(19) United States
(12) Patent Application Publication
(10) Pub. No.: US 2015/0251893 A1
(43) Pub. Date: Sep. 10, 2015

(54) ARRANGEMENT, A METHOD AND A COMPUTER PROGRAM FOR CONTROLLING FILLING OF A TANK

(71) Applicant: VOLVO CONSTRUCTION EQUIPMENT AB, Eskilstuna (SE)

(72) Inventors: Lenny Jonasson, Vasteras (SE); Aron Holmberg, Hagersten (SE)

(73) Assignee: VOLVO CONSTRUCTION EQUIPMENT AB, Eskilstuna (SE)

(21) Appl. No.: 14/430,563

(22) PCT Filed: Sep. 25, 2012
(86) PCT No.: PCT/SE2012/000146

§ 371 Date: Mar. 24, 2015

(51) Int. Cl. B67D 7/32; B67D 7/36; B67D 7/02

(52) U.S. Cl. CPC B67D 7/3209; B67D 7/0294; B67D 7/3218; B67D 7/362

(57) ABSTRACT

An arrangement is provided for controlling filling of a tank. The arrangement includes a sensor for measuring the level of liquid in the tank and a filling nozzle having an entrance tot receiving a tilling handle and filling the tank. The filling nozzle is provided with a controllable magnet, and the magnet is arranged to be activated or deactivated based on measurements performed by the level sensor. A method and a computer program for controlling filling of the tank are also provided.

### BACKGROUND AND SUMMARY

The invention relates to an arrangement for controlling for filling of a tank.

The invention is, according to an aspect thereof, applicable on vehicles, in particular working machines within the fields of industrial construction machines, such as wheel loaders and articulated haulers. Although the invention will be described with respect to a wheel loader, the application of the invention is not restricted to this particular machine, but may also be used in other vehicles.

In order to reduce the emissions of NOx a so called SCR-system can be used. Urea solution, such as for example DEF or AdBlue, is mixed to the exhausts and by chemical reactions the content of NOx can be reduced. For this reason, urea solution is intended to be carried in a specific tank arranged on the vehicle.

One problem is that urea solution has a freezing point at −1 TC, and the vehicle and the urea tank are sometimes exposed to temperatures below −11° C. over a longer period of time. In such a case the urea solution will freeze. During freezing the urea solution will expand in the same way as water. This means that during filling the tank, it has to be secured that an unfilled volume is remained in the tank, thereby allowing the urea solution to expand during freezing.

The position of the urea tank arranged on a working machine may vary, and in some cases filling of the tank cannot be performed directly into the tank. The filling nozzle of the tank is instead connected to the tank by means of a hose and arranged in a position different from the tank to be accessible to a filling handle and enable so called remote filling. Also when remote filling is used overfilling has to be avoided as explained above.

In addition, urea solution can be highly corrosive to some materials and for this reason overfilling and spillage should be avoided.

### SUMMARY OF THE INVENTION

It is desirable to provide an arrangement defined by way of introduction, which arrangement reduces the risk of overfilling and spillage when filling a tank with a liquid, such as a NOx reducing agent.

By the provision of an arrangement where the filling nozzle is provided with a controllable magnet and the magnet is arranged to be activated or deactivated based on measurements performed by the level sensor of the tank, the tank can be filled to the desired level. The controllable magnet, preferably an electromagnet, can be deactivated when the desired level of liquid in the tank is reached. This function of the arrangement can be used to control external filling equipment used for filling the tank. The controllable magnet can interact with a filling handle to stop the filling, for example by interaction with a magnetically activated sensor arranged in the filling pipe of the filling handle. The magnetically activated sensor in turn can be arranged for controlling a valve of the filling equipment.

The expression “controllable magnet” is intended to cover magnets having at least two different states. For example, the magnet can be deactivated which means that no magnetic field is generated or activated which means that a magnetic field is generated, or the two states can be two different levels of magnetic field. For this reason an electromagnet is preferably used.

Another option is to use a magnet which is displaceable between two different predetermined positions, where the first state corresponds to a first position of the magnet and the second state corresponds to a second position of the magnet. In such a case a permanent magnet can be used and the movement of the magnet can be performed by means of any mechanical device or compressed air, for instance.

A fixed permanent magnet that is not displaceable having only one state is not intended to be included in the expression “controllable magnets”.

In addition, the invention also relates, according to an aspect thereof, to an arrangement for filling, a tank and, according to a further aspect thereof, to a method for controlling filling of a tank.

Further advantages and advantageous features of the invention are disclosed in the following description.

### BRIEF DESCRIPTION OF THE DRAWINGS

With reference to the appended drawings, below follows a more detailed description of embodiments of the invention cited as examples.

In the drawings:

FIG. 1 is a lateral view of a wheel loader provided with an arrangement according to the invention,

FIG. 2 is one embodiment of an arrangement for controlling tilling of a tank according to the invention, and

FIG. 3 is one embodiment of an arrangement for filling a tank according to the invention.

### DETAILED DESCRIPTION

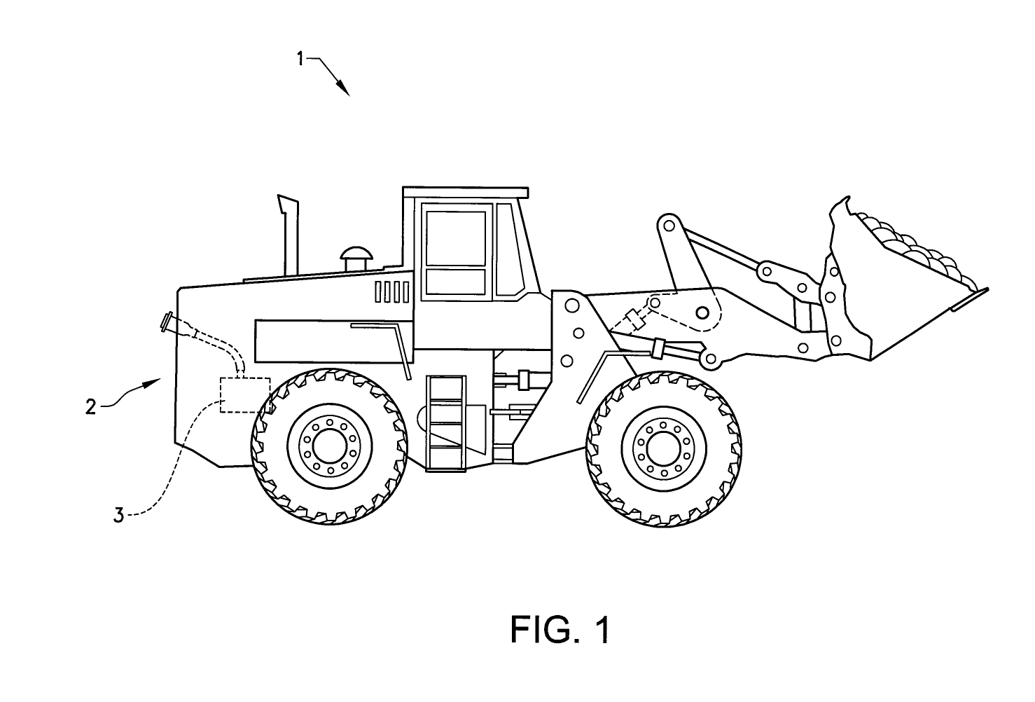

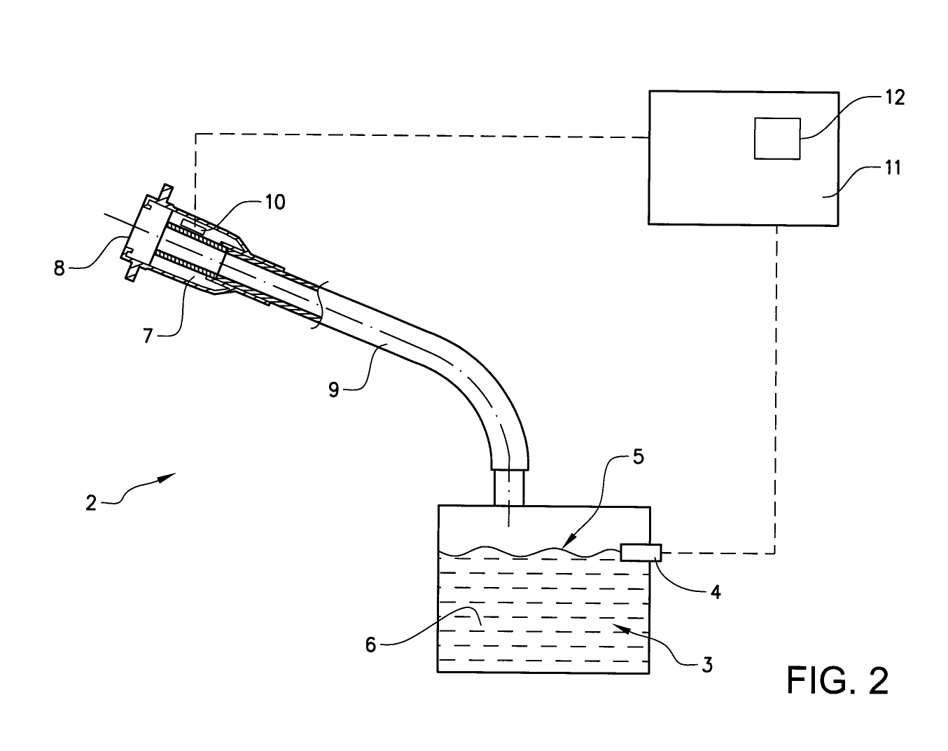

FIG. 1 shows a working machine 1 in the form of a wheel loader. The wheel loader is to be considered as an example of a vehicle to which the invention can be applied. The wheel loader is provided with an arrangement 2 for controlling filling of a tank 3 arranged on the wheel loader. The arrangement is further explained below with reference to FIG. 2.

FIG. 2 shows one embodiment of the arrangement 2 according to the invention. The schematically illustrated embodiment comprises a tank 3 provided, with a level sensor 4 for measuring the level 5 of liquid 6 in the tank 3. The tank 3 is arranged on a vehicle, such as for example a wheel loader as illustrated in FIG. 1 and in this example embodiment the arrangement is adapted to remote filling. The arrangement further comprises a filling nozzle 7 having an entrance 8 for receiving a filling handle. The nozzle 7 is arranged remote from the tank 3 and connected to the tank 3 by means of a hose 9, pipe or similar.

By means of an external filling handle (not shown in FIG. 2) and the filling nozzle 7 the tank 3 can be filled with a liquid. The liquid can be for example a NOx reducing agent, such as urea solution like DEF or AdBlue. The filling nozzle 7 is provided with a controllable magnet 10. The controllable magnet 10 is arranged to be activated or inactivated based on measurements performed by the level sensor 4.

Hereby the arrangement is provided with a function which can be used for controlling, the amount of liquid flowing from external filling equipment into the tank 3, provided that the filling equipment is sensitive to the different states of the controllable magnet 10. By means of the controllable magnet 10 the filling equipment can be controlled to not deliver any more liquid when a certain liquid level in the tank is reached or exceeded.

The controllable magnet 10 and the level sensor 4 are preferably connected to each other for transmitting signals from the level sensor 4 to the controllable magnet 10. A control unit 1 can be arranged for receiving signals from the level sensor 4 and transmitting signals to the controllable magnet 10 fix activation and deactivation thereof As an option the control unit 11 has a filter 12 for stabilizing the signals received from the level sensor 4. Such a filter 12 can be used to reduce the impact of a splashy liquid surface 5 in the tank 3.

The arrangement according to the invention can preferably be adapted to and used together with an open refilling system handle in accordance to ISO-22241-4. Such a handle has a magnetically activated sensor positioned in the filling pipe of the handle. By interaction with the magnetically activated sensor arranged in the filling pipe the flow of liquid to the tank can be controlled. In one embodiment, when the controlled magnet 10 is deactivated the magnetically activated sensor is unaffected and liquid is not allowed to flow into the tank 3, and when the controllable magnet 10 is activated the magnetically activated sensor is affected so as to control a valve of the filling equipment for allowing flow of liquid from the filling equipment.

Of course, according to another embodiment of the invention the controllable magnet can be used to stop the flow when activated and allow the flow when not activated or deactivated.

The level sensor 4 can be an inductive sensor or an ultrasonic sensor or other sensor suitable for determining the liquid level in the tank. The level sensor can be arranged at the outside of the tank 3 or at the inside of the tank 3. It is also possible to use a so called reed-switch sensor.

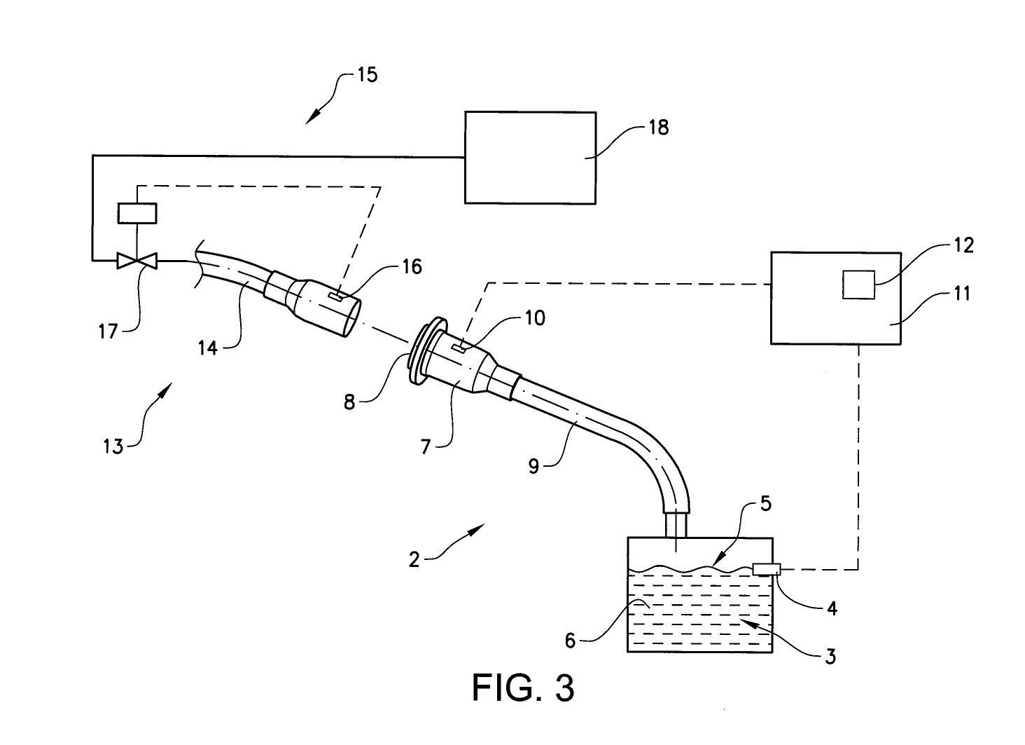

FIG. 3 shows a schematic illustration of one embodiment of an arrangement 13 for filling a tank 3 according to the invention. With reference to FIG. 3, only features which are not already described with reference to FIG. 2 above are hereinafter explained. Features that are identical or similar to the features of the arrangement illustrated in FIG. 2 have been given sane reference numerals as in FIG. 2, and are not further explained. The arrangement comprises a filling handle 14 and a filling device 15 for allowing and stopping a flow of liquid out from the filling handle 14. A tank 3 is provided with a nozzle 7 having an entrance 8 for receiving the filling handle 14 to enable filling of the tank 3. The arrangement further comprises a sensor 4 for measuring the liquid level 5 in the tank 3 The filling nozzle 7 is provided with a controllable magnet 10. The controllable magnet 10 is arranged to be activated or deactivated based on measurements performed by the level sensor 4.

The filling device 15 comprises a component 16 for interaction with the controllable magnet 10. This component 16 can be arranged in the filling handle 14, for example in the pipe of the filling handle 14. Preferably, a magnetically activated sensor 16 is arranged in the filling handle 14. The filling device 15 can comprise a valve 17, such as a shut off valve, for controlling a flow of liquid from a receptacle 8 to the tank 3 via the filling, handle 14 and the filling nozzle 7 of the tank 3. For example, during filling the tank 3, the level sensor 4 activates/deactivates the controllable magnet 10 which in turn affects the magnetically activated sensor 16 which in turn opens/closes the valve 17 for allowing/stopping the flow of liquid into the tank 3.

As soon as the invention is disclosed, other parts of the arrangement can be designed by a person skilled in the art by using for example standard components of filling equipment.

It is to be understood that the present invention is not limited to the embodiments described above and illustrated in the drawings; rather, the skilled person will recognize that many changes and modifications may be made within the scope of the appended claim.

1. An arrangement for controlling filling of a tank, the arrangement comprising a sensor for measuring the level of liquid in the tank and a filling nozzle having an entrance for receiving a filling handle and filling the tank, characterized in that the filling nozzle is provided with a controllable magnet, said magnet being arranged to be activated or deactivated based on measurements performed by the level sensor.

2. An arrangement according to claim 1, characterized in that the controllable magnet is an electromagnet.

3. An arrangement according to claim 1 or 2, characterized in that the controllable magnet is arranged to be activated when the liquid in the tank exceeds a certain predetermined level.

4. An arrangement according to any preceding claim, characterized in that the level sensor is an inductive sensor.

5. An arrangement according to any of claims 1-3, characterized in that the level sensor is an ultrasonic sensor.

6. An arrangement according to any preceding claim, characterized in that the filling nozzle is connectable to the tank by means of a pipe, hose or similar.

7. An arrangement according to claim 6, characterized in that the filling nozzle is arranged for remote filling of the tank.

8. An arrangement according to any preceding claim, characterized in that the arrangement comprises a control unit for receiving signals from the level sensor and transmitting signals to the controllable magnet for activation or deactivation thereof.

9. An arrangement according to claim 8, characterized in that the control unit has a filter for stabilizing the signals received from the level sensor to reduce the impact of a splashy liquid surface in the tank.

10. An arrangement according to any preceding claim, characterized in that the arrangement comprises a tank.

11. An arrangement according claim 10, characterized in that the tank is intended to contain a NOx-reducing agent, such as urea solution.

12. A vehicle provided with an arrangement according to any of claims 1-11.

13. An arrangement for filling a tank, the arrangement comprising a filling handle, a filling device for allowing and stopping a flow of liquid out from the filling handle, a filling nozzle having an entrance for receiving the filling handle and filling the tank, and a sensor for measuring the level of liquid in the tank, characterized in that the filling nozzle is provided with a controllable magnet, said magnet being arranged to be activated or deactivated based on measurements performed by the level sensor, said filling device comprising a component for interaction with the controllable magnet.

14. An arrangement for filling a tank according to claim 13, characterized in that said component is arranged in the filling handle.

15. An arrangement for filling a tank according to claim 13 or 14, characterized in that said component is a magnetically activated senor.

16. A method for controlling filling of a tank, comprising the steps of using a filling nozzle having an entrance for receiving a filling handle and filling the tank, and determining the level of liquid in the tank, characterized by using the determined liquid level for activating or deactivating a controllable magnet of the filling nozzle for controlling filling of the tank.

17. A computer program comprising program code means for performing the steps of claim 16 when said program is run on a computer.

18. A computer readable medium comprising a computer program according to claim 17.
